(19) United States
(12) Patent Application Publication
(10) Pub. No.: US 2020/0118213 A1
(43) Pub. Date: Apr. 16, 2020

(54) Electronic System and Method of Consumption-based Retirement Planning

(71) Applicant: Advanced Practice Networks, LLC, Claremont, CA (US)

(72) Inventors: Kelly Kidwell, Claremont, CA (US); Eric McDermott, Claremont, CA (US)

(21) Appl. No.: 16/156,479

(22) Filed: Oct. 10, 2018

(51) Int. Cl. G06Q 40/06; G06Q 40/02; G06Q 40/08

(52) U.S. Cl. CPC G06Q 40/06; G06Q 40/08; G06Q 40/02

(57) ABSTRACT

A method of electronically calculating a cost of funding an acceptable retirement of an individual includes: receiving consumption data corresponding to a current or intended level of financial consumption of the individual; calculating a required annual income of the individual based on received consumption data of the individual; receiving portfolio data corresponding to a balance of a retirement portfolio of the individual; retrieving cost data corresponding to costs of annuity products purchased at a plurality of ages of the individual; plotting an estimated future balance of the retirement portfolio of the individual at an assumed rate of return against a plurality of ages of the individual; plotting costs of annuity products against the plurality of ages of the individual; visually displaying the plotted estimated future balance of the retirement portfolio of the individual and the costs of the annuity products.

### FIELD

This disclosure relates to the field of retirement. More particularly, this disclosure relates to a method of determining sufficiency for a retirement income based on data related to an individual's consumption and the cost of guaranteed income products.

### BACKGROUND

Globally most people now live past age 65, while in industrialized countries almost half of those reaching age 65 will live to be 85 or older (United Nations 2013). These trends lend new urgency to the question of how to finance retirement. The primary goal of retirement financial strategy is to maintain an acceptable lifestyle for the duration of a person's life, in addition to maintaining liquidity for unexpected life events, and meeting bequest goals. Yet even sophisticated investors often lack a clear understanding of what this actually requires. At what point can investors say with confidence that they have achieved sufficiency—ensuring that their consumption will never fall below a level that they consider to be acceptable? Presumably this knowledge would be quite valuable to retirees and their families. Moreover, achieving sufficiency allows investors to focus on surplus accumulation strategies that may differ with respect to crucial variables such as risk tolerance and relevant time horizons.

For the past few decades, the personal finance industry has adhered to a planning model in which clients are advised to accumulate enough capital through saving and investment to support a retirement income stream withdrawn at a “sustainable” rate, conventionally set at four percent. This capital-at-work strategy relies on speculation about market performance and retiree longevity, and thus carries inherent risks including potential financial ruin if market returns fall below historical averages, and inefficiencies from consuming too much or too little relative to bequest goals.

A viable retirement strategy must provide a sustained income stream despite uncertainty in lifespans and in the performance of the market-based assets used to fund those lifespans. Life expectancy for people who reach age 65 grew from 11 years in 1950-1955 to 16 years in 2005-2010, and demographers report “no evidence for an approaching upper limit to human life expectancy”. Not only are retirees living longer, but the variability and accompanying uncertainty in lifespans from one individual to the next has actually grown.

The history of retirement finance can be understood as an evolution of risk transfer strategies. The cost of longevity has two components—the systemic trend of longer lives in the general population, and the uncertainty associated with any given individual's lifespan. Until the mid-20th century, it was common for families in the United States and Western Europe to pool individual longevity risk using a financial product called a tontine, in which people would pay premiums that would be distributed to those surviving after a specified period, such as 20 years. According to Ransom and Sutch, in 1905, fully 64 percent of life insurance policies in the United States included some form of tontine contract as a promise-based income stream for protection against longevity costs. Others managed the risk of longevity by continuing to work for as many years as possible—foregoing the modern notion of retirement—and by relying on family members to care for them when they were no longer able to do so.

When tontines were banned as part of a government crackdown on the finance industry, people relied more heavily on defined benefit plans, another promise-based approach in which an employer or government entity provides a guaranteed level of income for the duration of a retiree's life. These providers were protected from the risk of variance in individual longevity by virtue of having a large pool of recipients; they could not, however, avoid the systemic increase in costs due to growing average longevity in the population as a whole. Systemic growth in longevity is not a risk per se, but a predictable and growing expense—one that has strained government budgets and has led many companies to shun defined benefit plans in favor of defined contribution plans. From 1974 through the first quarter of 2016, the proportion of defined contribution plans and individual retirement accounts increased tenfold relative to private sector defined benefit plans.

As individuals are now forced to assume greater responsibility for financing their retirement, they are exposed to both types of longevity costs: they are likely to have longer and costlier retirements than did their parents and, without the ability to spread variance in longevity costs across a large pool of retirees, they face the additional challenge of managing for greater uncertainty in their individual lifespans.

Funding a costly yet uncertain individual lifespan with uncertain individual market returns is a source of considerable concern for many consumers. These concerns are amplified by the capital-at-work model—the predominant approach in the financial industry today—which emphasizes growth in assets during the accumulation phase of an individual's working years followed by a sustainable withdrawal rate from these assets during the decumulation phase in retirement. As Tressider explains, when relying exclusively on market-based assets, determining the right withdrawal rate is a high-stakes game: a one percent change in withdrawal rate amounts to a 25 percent change in retirement income under the conventional industry standard of 4 percent annual withdrawals. “The razor thin margin between 1% too much [spending] and getting it right is literally the difference between poverty and financial security” (Tressider 2012, 115). The “4 percent rule” was originally developed by Bengen (1994), who modeled sustainable withdrawal rates with greater precision than earlier models that had relied on average rates of return and had often recommended 5 to 7 percent withdrawal rates. Bengen showed that below-average market performance early in retirement can have negative consumption consequences even if the market subsequently rebounds. Bengen's work was further refined by Cooley et al. (2003) in what became known as the Trinity Study, and by subsequent research that took account of factors such as permutations in portfolio allocations and the frequency with which retirees adjust their strategies.

The limitations of the 4 percent rule have been revealed by Pfau (2010, 2011), who argues that this approach relies too heavily on historical data from US stocks and bonds. Indeed, when followed faithfully, the 4 percent rule can lead to financial ruin. In Monte Carlo simulations across a range of portfolio allocations consisting of stocks, bonds, and cash, Ameriks and colleagues (2001) find that adherence to the 4 percent rule will cause 5 to 25 percent of retirees to be financially destitute within 25 years. The results are highly sensitive to the time horizons chosen for the simulations (see also Finke and Blanchett 2016, 25), which confirms the risk of tethering retiree wellbeing to a strategy that relies almost exclusively on uncertain market returns. The guesswork inherent in choosing a sustainable withdrawal rate also leads to inefficiencies, such as drawing down too little and leaving unintentionally large bequests alongside lower-than-desired rates of consumption (Scott et al. 2009). Some industry analysts have made downward adjustments to the “safe” withdrawal rate, but the more fundamental problem, according to Scott and colleagues (2009, 2), is that “This rule and its variants finance a constant, non-volatile spending plan using a risky, volatile investment strategy.”

The benefits of pooling longevity risk have been understood for centuries, but the modern logic of annuitization for individual investors received its first formal treatment by Menahem Yaari in 1969, in his article “Uncertain Lifetime, Life Insurance, and the Theory of the Consumer.” Using a series of simplifying assumptions such as the absence of a bequest motive, Yaari concluded that, in theory, many retirees should place 100 percent of their savings in annuities instead of bonds. Yaari's calculations have served as a benchmark for subsequent studies that incorporate more realism into their models including bequest motives, the impact of fees on annuity prices, liquidity needs for large health expenditures, risk pooling among family members, changes in consumption levels over the course of retirement, and the limited range of available annuity products relative to potential demand (Davidoff et al. 2005; Ameriks et al. 2001; Mitchell et al. 1999). When these factors are incorporated, full annuitization of retiree wealth rarely makes sense, yet an optimal level of annuitization is still far higher than that observed in the choices made by retirees. In terms of income security, Ameriks and colleagues (2001, 72) find that when adding 25 percent or 50 percent annuitization, “For all time periods and for all portfolios, the addition of the annuity leads to a decline in the portfolio failure rates.” None of these authors recommend complete annuitization; dampening the oscillations in retirement income comes at the cost of liquidity and reduces the possibility for large wealth gains via heavy market exposure. But research by Pfau (2013) and Finke and Blanchett (2016) confirms the advantages of including fixed-income annuities as a substantial part of a retiree portfolio, as these provide higher retirement income than do bonds while protecting against longevity risk.

The demonstrated benefits of annuities stand in sharp contrast to their lack of popularity relative to market-based investments. In the ten-year period spanning 2006-2015, individual investors in the United States purchased $133 billion in variable annuities and $104 billion in fixed annuities—totaling only 17% of the 14 trillion in assets that investors held in IRAs and defined contribution plans in the first quarter of 2016.³ The annuity puzzle was first posed by Friedman and Warhawsky (1990, 136) who observed, “Well-developed markets for life annuities do exist in the Unites States . . . The puzzle is that so few people choose to use them.” The lackluster demand for products offering a guaranteed lifetime income stream is striking even after taking into account the role of existing annuity-like programs such as Social Security and private sector defined-benefit plans. These authors find that some of the discrepancy between theoretically optimal and observed annuitization levels can be accounted for by risk-sharing strategies within families, the desire to leave wealth for heirs, and annuity prices that are unattractive from an expected value standpoint. Additional research has found that the ideal annuitization level may be reduced by the need for liquidity to handle large uninsurable health expenses (Reichling and Smetters 2015)—although in Europe, where out-of-pocket health expenses are negligible for retirees, annuities remain unpopular (Peijnenburg et al. 2016).

Poterba and colleagues (2011) find that many US households simply have so little in the way of retirement savings beyond home equity that the potential for annuitization is small for two-thirds of the population. As we noted earlier, the challenge of financing retirement has been transferred back to individual households as part of the historical evolution of managing longevity risk. It appears, however, that American consumers did not “get the memo”; society has not made a corresponding adjustment to levels of consumption and savings.

None of these factors can explain the size of the gap between optimal and actual annuitization levels. Bernartzi and colleagues (2011, 146) report that “even accounting for these elements, welfare gains from annuitization are significant, at least for those with non-negligible financial assets.” This has led others to explore the behavioral factors that might lead people to make decisions that are not in their own best interests (Brown 2007; Hu and Scott 2007).

Friedman and Warshawsky (1990) raise the possibility of behavioral drivers of sub-optimal annuitization in the closing passage of their original work on the annuity puzzle, although they do not explore the issue in any detail. In our experience, the annuities market has been chilled by the negative publicity surrounding the unsavory sales practices of some firms pushing annuity contracts with terms that offer dubious benefits to clients. A fuller evaluation of the barriers to annuitization is offered by Jeffrey Brown, who has conducted a series of studies on retirement finance drawing on insights from behavioral economics, notably Tversky and Kahneman's (1981) findings on framing effects. Brown and colleagues (2013, 27) report that the manner in which information is presented to clients influences their choice of retirement financial strategies. “Specifically, when alternative financial products are presented in a consumption frame, which highlights consequences for consumption over the lifecycle, consumers strongly preferred annuities to other types of financial products, including savings accounts. When these same product choices are presented in an investment frame that focuses on risk and return features, savings accounts and other financial products were strongly preferred to annuities.”

What is needed, therefore, is a system and method of consumption-based retirement planning for informing the investment, labor, and lifestyle choices of prospective retirees to enable individuals to understand implications of their consumption and alternative retirement strategies.

### SUMMARY

The above and other needs are met by methods of planning for costs of retirement. In a first aspect, a method of electronically calculating a cost of funding an acceptable retirement of an individual, the method includes: receiving consumption data corresponding to a current level of financial consumption of the individual; calculating a required annual income of the individual based on received consumption data of the individual; receiving portfolio data corresponding to a balance of a retirement portfolio of the individual; retrieving cost data corresponding to costs of an annuity product purchased at a plurality of ages of the individual; plotting an estimated future balance of the retirement portfolio of the individual at an assumed rate of return against a plurality of ages of the individual; plotting costs of the annuity product against the plurality of ages of the individual; visually displaying the plotted estimated future balance of the retirement portfolio of the individual and the costs of the annuity product.

### BRIEF DESCRIPTION OF THE DRAWINGS

Further features, aspects, and advantages of the present disclosure will become better understood by reference to the following detailed description, appended claims, and accompanying figures, wherein elements are not to scale so as to more clearly show the details, wherein like reference numbers indicate like elements throughout the several views, and wherein:

FIG. 1 shows a plot of a displayed curve illustrating a method of determining a minimally sufficient retirement income for immediate release of a promised stream of income according to one embodiment of the present disclosure;

FIG. 2 illustrates an example of the cost of funding a particular annual income beginning at a desired age for deferred release of a promised stream of income according to one embodiment of the present disclosure;

FIG. 3 illustrates a network for determining a sufficiency for retirement income according to one embodiment of the present disclosure;

FIG. 4 illustrates an embodiment of a network for determining a sufficient retirement income according to one embodiment of the present disclosure; and

FIG. 5 illustrates a schematic of a user device according to one embodiment of the present disclosure.

### DETAILED DESCRIPTION

Various terms used herein are intended to have particular meanings. Some of these terms are defined below for the purpose of clarity. The definitions given below are meant to cover all forms of the words being defined (e.g., singular, plural, present tense, past tense). If the definition of any term below diverges from the understood and/or dictionary definition of such term, the definitions below control.

Methods and embodiments herein provide for electronically determining the lowest general cost of guaranteeing a demonstrably acceptable level of consumption for the rest of a person's life by transferring longevity risk to third parties. The cost of sustained consumption is driven by two readily measurable variables. The first is a person's current level of consumption, which offers an evidence-based indicator of what he or she considers to be an acceptable lifestyle. The individual may revise this “demonstrably acceptable” number if current consumption differs from perceived future needs. But in every case, current consumption offers a baseline measure that is derived from revealed preferences and is documented in spending data that are readily available to people planning their retirement.

The second variable driving the cost of sustained consumption is the number of years for which a given consumption level must be sustained. Guaranteed income is available through annuities and related products that offer a contractual promise to provide income, either for a specified period or for the duration of one's life. These contracts as contractually obligated assets or income, meaning their value derives from the credibility and terms of the contract rather than from unpredictable shifts in market opinion, which is the case for market-driven investments such as stocks. The cost of guaranteed lifetime income declines as a function of retiree age because it is priced by providers who pool longevity risk and know that older consumers will, on average, require fewer years of payments. For consumers at every income level, the market price of sustained consumption has a negative slope.

Embodiments of the present disclosure include plotting the two variables of current or intended consumption and the price of sustaining that consumption to determine a point at which an individual can afford to purchase guaranteed income that may also be adjusted for inflation; including factors such as consequences of changes in consumption levels, interest rates, and retirement dates; as well as funds available as liquidity for life events such as major health expenses and for funding surplus goals such as bequests. Resulting displays of the plotting of an individual's consumption and price of that consumption enable an individual to evaluate an individual's retirement and reveal the impact of including contractually obligated assets/income in a retirement plan.

As referred to herein, a sufficient income is an income necessary to ensure a demonstrably acceptable level of consumption, operationalized as a current consumption of a given individual or couple. Sufficient income is readily measured in the context of retirement planning and electronic transaction records of individuals because all consumers have already revealed what is considered to be an acceptable consumption level—namely, a current consumption level of the individual. A current consumption level of an individual is analyzed because current consumption is consistent with research demonstrating that individuals place a higher value on avoided losses than on gains, and because current consumption reveals preferences based on years of spending behavior of individuals.

Individuals may manage and transfer risk by owning both market-sensitive assets/income and guaranteed assets. A value of a market-sensitive asset/income, such as a traded stock or a small business, is a function of the value that the market places on the asset at a given point in time. Market valuation is characterized by uncertainty, which typically increases the farther one projects into the future. In contrast, a value of a guaranteed asset, such as a fixed annuity, derives from a legally enforceable contract through which an issuer of the asset makes a specific financial promise, such as $1,000 in annual income for as long as the buyer lives. The issuer agrees to a contractual performance that entitles the buyer to take legal action to perfect a claim in the event of a failure to perform. Guaranteed assets may be offered by banks, insurance companies, governments, nonprofit organizations, and companies selling corporate bonds held to maturity.

In retirement, an individual may consume income but not assets. For example, social security provides guaranteed income, but retirees do not own an underlying asset as they cannot trade or invest funds contributed from paychecks to the social security system. A given investment product may include both contractually obligated assets/income and market-sensitive asset/income attributes. For example, an owner of a rental property derives guaranteed income from tenants—based on a legally enforceable contract—but a price of the property itself may be drive by forces of market valuation. A corporate bond has characteristics similar to a guaranteed asset generating guaranteed income.

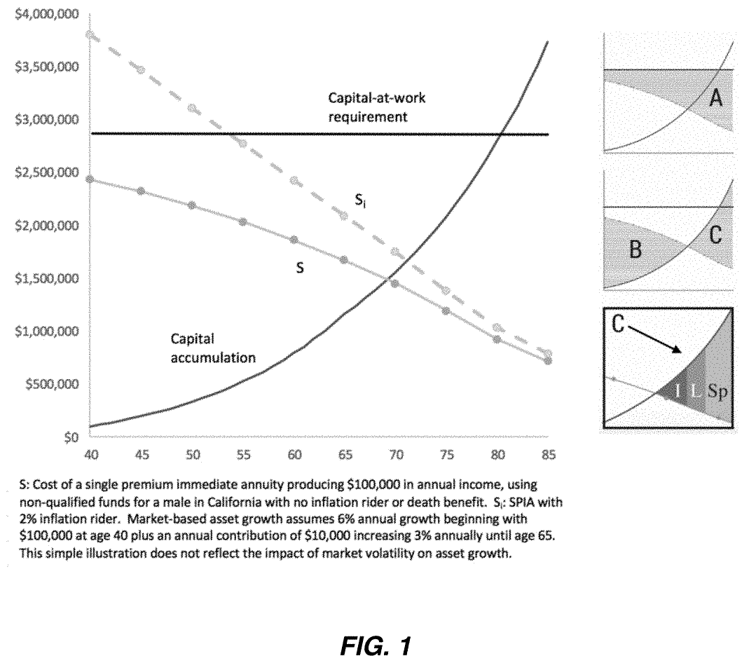

Embodiments of the present electronic system and method of determining in real time a general cost of funding an acceptable lifestyle for the rest of an individual's life. Systems and methods of the present disclosure visually display the individual's cost as a function of the individual's age, as shown in FIG. 1. A slope of the displayed cost slopes downward as a function of the individual's age as a result of mortality credits that drive a price of contractually obligated assets/income. A cost of annuities reflects that annuities become less expensive over the course of an individual's lifetime because issuers recognize that annual payments to an older individual will, on average, continue for a shorter period than is the case for younger consumers. Unlike a price of a bond instrument, only mortality-based guaranteed income changes in price with an age of the purchaser.

FIG. 1 compares a method of displaying cost of funding an acceptable lifestyle for an individual in retirement as compared to a conventional capital-at-work model for a hypothetical investor planning for retirement. In the example of FIG. 1, a starting portfolio is assumed to have $100,000 in stocks and bonds at age 40, growing at an average of 6 percent in after-tax annual return, as well as new annual contributions from the person's paycheck beginning at $10,000 with the size of the contribution increasing 3 percent each year until age 65. The capital accumulation curve of FIG. 1 corresponds to a conventional strategy of accumulating capital through market assets. In this example, a retiree's demonstrably acceptable consumption level, using current consumption as a proxy, is assumed to be $120,000 per year, of which $20,000 will be provided by Social Security, leaving a gap of $100,000. Under conventional models that predominate in the financial advising industry, shown herein as a capital requirement, assuming a 3.5 percent withdrawal rate (a slightly more conservative version of the 4 percent rule), the retiree would need to have accumulated $2.86 million to achieve an annual income supplement of $100,000—a goal that is not reached until age 80.

If the scenario is revised so that the 40-year old begins with $200,000, the individual still does not reach the requirement for sustainable income until age 75. In both scenarios, presumably the retiree would need to begin decumulation sooner than this point, drawing down assets and thereby reducing the slope of the capital accumulation curve, which has the effect of further postponing fulfillment of capital requirements.

Curve S in FIG. 1 is based on a cost of a single premium immediate annuity (SPIA) purchased at different ages. For simplicity, it is assumed that the buyer purchases all of the SPIAs in one transaction. By definition, SPIA payments begin immediately upon purchase. SPIA prices, which vary over time, are obtained electronically, as described in greater detail below. In the example of FIG. 1, SPIA prices, which vary over time, are based on a single person in California with non-qualified assets, no survivorship benefits, no inflation rider, and no payout if death occurs before the designated payout period. As in the example above, the retiree begins with $100,000 in savings at age 40 and requires an annual income after Social Security of $100,000. Curve Sᵢ introduces inflation and illustrates the cost of purchasing a two percent inflation adjustment rider as part of the guaranteed income contracts.

At a point where the capital accumulation curve crosses the inflation-adjusted Curve Sᵢ, the prospective retiree can afford to purchase enough guaranteed income to ensure at least minimal adequacy for the rest of the retiree's life. In the example of FIG. 1, a convergence point occurs at age 72, eight years earlier than is the case under the 3.5 percent version of the capital accumulation curve.

Embodiments shown in FIG. 1 include advantages for informing the investment, labor, and lifestyle choices of prospective retirees. By framing retirement finance in terms of consumption, embodiments of the present disclosure assist to overcome the myopic focus on rates of return and asset growth that typically contributes to sub-optimal levels of annuitization. By visually displaying Curve Sᵢ, a consumer can view what point they can, through a combination of risk transfer and risk management, sustain an acceptable lifestyle for the rest of their life. Because the displayed Curve S represents the lowest cost of ensuring sustained consumption, a retiree who does not save enough to reach the Curve S will fail to meet their consumption targets, thereby requiring a change in lifestyle or financial dependency on other family members.

FIG. 1 further illustrates that investments benefitting from mortality credits lead to financial adequacy sooner than is possible through an exclusive reliance on traditional capital models. Unlike risk associated with market-sensitive assets/income, guaranteed assets/income reach an acceptable level of adequacy sooner. Assuming market assets used to purchase the guaranteed assets are growing at a non-zero rate, the downward slope of Curve S produces convergence at area B of FIG. 1. Convergence may further be possible during a period of negative growth in the value of the market investments used to purchase the annuity, so long as the rate of market decline is less than the declining price of the annuity.

In contrast, under a traditional capital asset model if a person has not saved sufficiently it becomes nearly impossible to catch up in later years. The additional capital required, illustrated as area A in FIG. 1, reflects the cost to the consumer of managing the risk of market volatility and uncertain longevity, in contrast with the substantially lower capital required to transfer the risk to third parties.

Convergent points of FIG. 1 show a minimum amount of financial adequacy, but do not consider additional contingencies that may adversely affect consumption levels in retirement. Having transferred the risk of funding two percent inflation-adjusted consumption, consumers need to manage some risk—leaving some assets in market assets—to meet their sufficiency and surplus goals. Area C of FIG. 1 shows two additional steps that may be necessary for financial adequacy. The first consists of assets devoted to protection against inflation (I) beyond the amount that can be readily purchased in annuities contracts. Actual inflation may rise well above two percent, and market assets tend to increase in value as inflation rises.

Next, consumers must devote assets to liquidity (L) for funding major unanticipated life events such as chronic illness or supporting a family member in need. Whereas general inflation affects an individual's Curve Sᵢ only slowly, the appearance of a large, long term, and difficult-to-predict expense of this nature can result in a significant upward shift of the Curve Sᵢ. The certainty associated with transferred risk and guaranteed income comes at the cost of liquidity; consumers typically cannot tap funds used to purchase fixed annuities beyond regular income payments of the fixed annuities. To meet liquidity needs for major life events, retirees must manage some risk through market investments. The amount of liquidity needed for this purpose will differ according to individual preferences and whether the person has already transferred some risk through the purchase of a long-term care insurance contract. Unlike annuities, the cost of long-term care policies increases with age, suggesting that this is one of the first risk transfers that should take place for consumers beginning in their 50s, although the cost of funding this type of policy typically dissuades a consumer from doing so.

Area C shown in FIG. 1 is surplus (Sp), which includes bequests, charitable contributions, or an increase in living standards relative to current consumption. After transferring risk to achieve financial adequacy, a consumer can afford to manage some risk in funding growth of surplus assets through market investments, benefiting from the upside of greater returns while being able to tolerate the downside risk of reduced surplus consumption goals, now that sufficiency goals have been met.

The point at which a person can afford to fully fund financial adequacy is distinct from the question of when an individual should do so from a cost effectiveness standpoint. To determine at what point in a consumer's lifetime do guaranteed assets become a less expensive means of producing a given retirement income stream compared to the capital model, the cost at a given age of funding an amount in annual income beginning at a desired age.

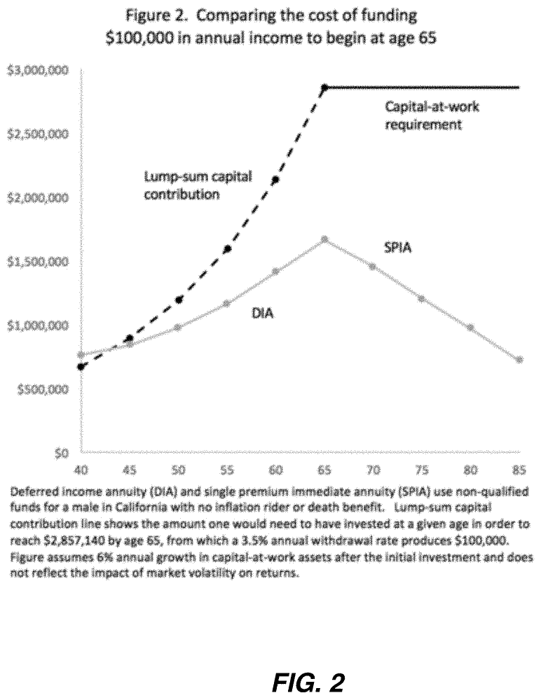

Referring to FIG. 2, a plot of the cost at any given age of funding $100,000 in sustained annual retirement income to begin at age 65 is illustrated. Unlike the plot of FIG. 1, a lump-sum capital contribution line in FIG. 2 does not display growth in total assets, but rather an amount of capital that one would need to invest one time, at any given age, in order to reach the capital requirement of $2,857,140 (of which 3.5% produces $100,000) by age 65, assuming a 6 percent annual after-tax growth rate from the time of the lump-sum investment until age 65.

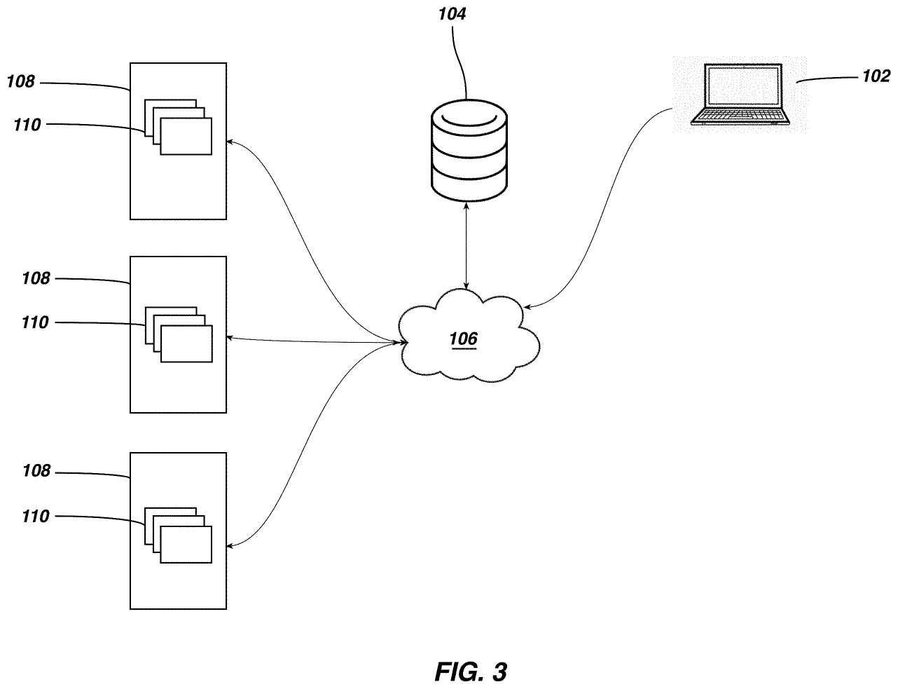

Referring now to FIG. 3, methods and embodiments described above are implemented to enable Curve Sᵢ of FIG. 2 to be plotted based on up-to-date data including consumer consumption data and data related to the cost of guaranteed income. A user device 102 is configured to receive input from a user and to display Curve S/Sᵢ on a display of the user device 102, wherein the data displayed to a user on the user device 102 is up-to-date based on recent financial data as described in greater detail below.

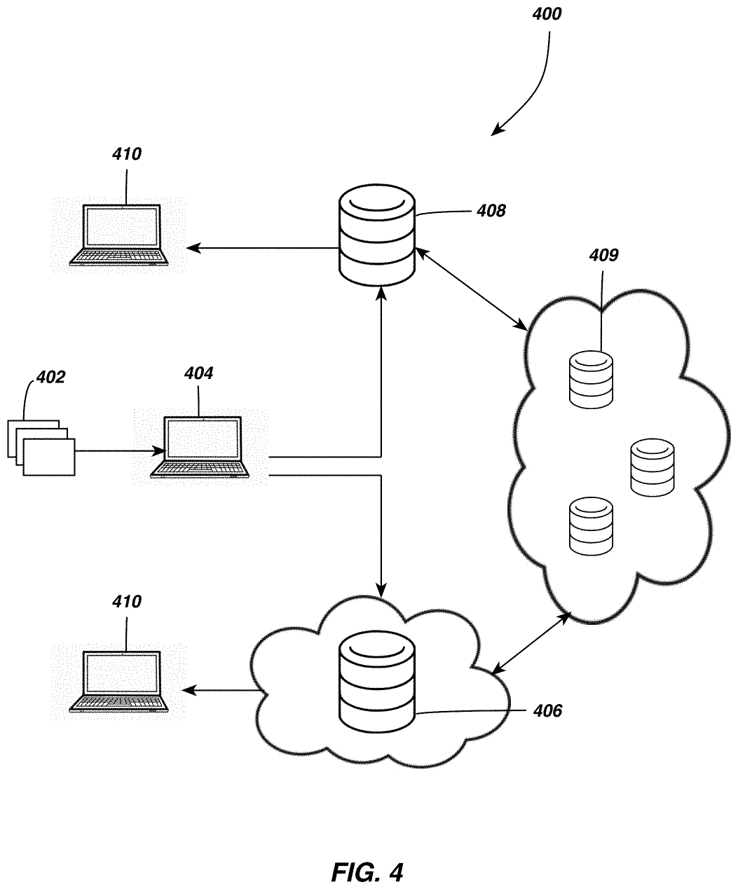

Referring now to FIG. 4, a diagram of a network for determining a sufficient retirement income 400. Personal data 402 of an individual, such as age, income, and other data may be input from terminal 404 and transmitted to a remote aggregate database 406 or local aggregate database 408 for analysis. The remote aggregate database 406 and local aggregate database 408 includes data from one or more remote databases 409 including sources of data such as mortality, actuarial, annuitization, market rate, and other similar data. In one embodiment, data is retrieved and transmitted to the aggregate database 406 based on personal data received from terminal 404. For example, data specific to the individual may be retrieved on the aggregate database 406 for analysis and output as described herein. Data may be retrieved on the aggregate database 406 periodically such as in batches, or alternatively may be provided in real-time or in response to specific data received on the aggregate database 406 from terminal 404.

Data received on the aggregate database 406 is analyzed based on data from the remote databases 408 and data from the terminal 404. Analyzed data is used to generate the curve described herein that is displayed on one or more terminals 410. A user may interactively view data displayed on the terminal 410 for further output, transmission, or analysis. While FIG. 4 shows terminals 404 and 410 as separate from one another, it is also understood that terminals 404 and 410 may be a single terminal that is configured to both input and display data according to embodiments described herein.

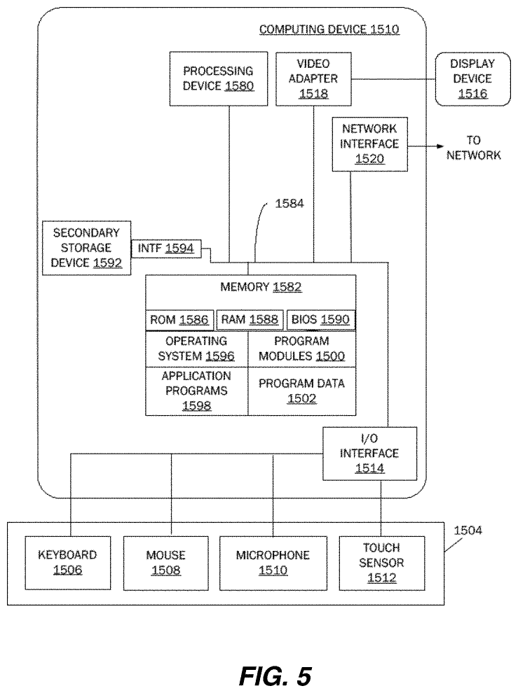

The user device 102, such as the terminal 404 or 410 of FIG. 4, is preferably one of a personal computer, smartphone, tablet, or other computing device. Referring now to FIG. 5, an exemplary architecture of a computing device that can be used to implement aspects of embodiments of the present disclosure is illustrated. The computing device illustrated in FIG. 4 can be used to execute the operating system, application programs, and software modules (including the software engines) described herein.

The computing device 1510 includes, in some embodiments, at least one processing device 1580, such as a central processing unit (CPU). A variety of processing devices are available from a variety of manufacturers, for example, Intel or Advanced Micro Devices. In this example, the computing device 1510 also will likely include a system memory 1582, and a system bus 1584 that couples various system components including the system memory 1582 to the processing device 1580. The system bus 1584 is one of any number of types of bus structures including a memory bus, or memory controller; a peripheral bus; and a local bus using any of a variety of bus architectures.

Examples of computing devices suitable for the computing device 1510 include a desktop computer, a laptop computer, a tablet computer, a mobile computing device (such as a smart phone, a tablet device, or other mobile devices), or other devices configured to process digital instructions.

The system memory 1582 includes read only memory 1586 and random-access memory 1588. A basic input/output system 1590 containing the basic routines that act to transfer information within computing device 1510, such as during start up, is typically stored in the read only memory 1586.

The computing device 1510 also includes a secondary storage device 1592 in some embodiments, such as a hard disk drive, for storing digital data. The secondary storage device 1592 is connected to the system bus 1584 by a secondary storage interface 1594. The secondary storage devices 1592 and their associated computer readable media provide nonvolatile storage of computer readable instructions (including application programs and program modules), data structures, and other data for the computing device 1510.

Although the exemplary environment described herein employs a hard disk drive as a secondary storage device, other types of computer readable storage media are used in other embodiments. Examples of these other types of computer readable storage media include magnetic cassettes, flash memory cards, digital video disks, Bernoulli cartridges, compact disc read only memories, digital versatile disk read only memories, random access memories, or read only memories. Some embodiments include non-transitory media. Additionally, such computer readable storage media can include local storage or cloud-based storage.

A number of program modules can be stored in secondary storage device 1592 or memory 1582, including an operating system 1596, one or more application programs 1598, other program modules 1500 (such as the software engines described herein), and program data 1502. The computing device 1510 can utilize any suitable operating system, such as Microsoft Windows™ Google Chrome™, Apple OS, and any other operating system suitable for a computing device. Other examples can include Microsoft, Google, or Apple operating systems, or any other suitable operating system used in tablet computing devices.

In some embodiments, a user provides inputs to the computing device 1510 through one or more input devices 1504. Examples of input devices 1504 include a keyboard 1506, mouse 1508, microphone 1510, and touch sensor 1512 (such as a touchpad or touch sensitive display). Other embodiments include other input devices 1504. The input devices are often connected to the processing device 1580 through an input/output interface 1514 that is coupled to the system bus 1584. These input devices 1504 can be connected by any number of input/output interfaces, such as a parallel port, serial port, game port, or a universal serial bus. Wireless communication between input devices and the interface 1514 is possible as well, and includes infrared, BLUETOOTH® wireless technology, 802.11a/b/g/n, cellular, or other radio frequency communication systems in some possible embodiments.

In this example embodiment, a display device 1516, such as a monitor, liquid crystal display device, projector, or touch sensitive display device, is also connected to the system bus 1584 via an interface, such as a video adapter 1518. In addition to the display device 1516, the computing device 1510 can include various other peripheral devices (not shown), such as speakers or a printer.

When used in a local area networking environment or a wide area networking environment (such as the Internet), the computing device 1510 is typically connected to a network through a network interface 1520, such as an Ethernet interface. Other possible embodiments use other communication devices. For example, some embodiments of the computing device 1510 include a modem for communicating across the network.

The computing device 1510 typically includes at least some form of computer readable media. Computer readable media includes any available media that can be accessed by the computing device 1510. By way of example, computer readable media include computer readable storage media and computer readable communication media.

Computer readable storage media includes volatile and nonvolatile, removable and non-removable media implemented in any device configured to store information such as computer readable instructions, data structures, program modules or other data. Computer readable storage media includes, but is not limited to, random access memory, read only memory, electrically erasable programmable read only memory, flash memory or other memory technology, compact disc read only memory, digital versatile disks or other optical storage, magnetic cassettes, magnetic tape, magnetic disk storage or other magnetic storage devices, or any other medium that can be used to store the desired information and that can be accessed by the computing device 1510.

Computer readable communication media typically embodies computer readable instructions, data structures, program modules or other data in a modulated data signal such as a carrier wave or other transport mechanism and includes any information delivery media. The term “modulated data signal” refers to a signal that has one or more of its characteristics set or changed in such a manner as to encode information in the signal. By way of example, computer readable communication media includes wired media such as a wired network or direct-wired connection, and wireless media such as acoustic, radio frequency, infrared, and other wireless media. Combinations of any of the above are also included within the scope of computer readable media.

The computing device illustrated in FIG. 5 is also an example of programmable electronics, which may include one or more such computing devices, and when multiple computing devices are included, such computing devices can be coupled together with a suitable data communication network so as to collectively perform the various functions, methods, or operations disclosed herein.

A user inputs parameters of a prospective retiree into the user device 102. Parameters inputted into the user device 102 may include age, marital status, retirement goals, location, types of desired annuity products, and a risk profile of the retiree. Parameters of the individual may be transmitted to and stored on database 104 over a network 106, such as the Internet, for further analysis as described in greater detail below. A profile of the retiree may be created, and inputted parameters may be stored as associated with the profile of the retiree on the database 104.

The database 104 and user device 102 may further be in communication with one or more third party data sources 108. Third party data sources 108 may include sources of data from companies including data related to annuity data and/or longevity/mortality data. Third party data sources 108 may further include banking data, such as a plurality of financial records 110 of the third party data sources 108 associated with the particular prospective retiree. Data from the third party data sources 108 may be aggregated on the database 104.

Upon request from a user on the user device 102, data from the third party data sources 108 may be analyzed in relation to the parameters of the prospective retiree to generate the Curve S/Sᵢ described above for the particular retiree. The resulting Curve S/Sᵢ based on the particular parameters of the retiree and data received from the third party data sources 108 is displayed on the user device 102 and provides a real-time presentation of the retiree's Curve S/Sᵢ and other data related to retirement of the retiree.

Methods and embodiments described herein enable guidance for retirement planning at any given point in time, based on up-to-date data including market performance, lifestyle cost, taxes, and interest rates. Advisors and clients may wish to revisit the Curve S/Sᵢ on a periodic or systematic basis, such as annually. The Curve S/Sᵢ displayed in FIG. 1 is affected by lifestyle cost and by the price of the products generating income to support that lifestyle. When interest rates rise, the price of guaranteed annuity income decreases, shifting the Curve S/Sᵢ downward and leading to earlier convergence. If taxes or spending increase, the Curve S/Sᵢ moves upward. As noted in the examples above, Social Security and other defined-benefit program payments shift the Curve S/Sᵢ downward. The Curve S/Sᵢ shows the remaining essential yet unfunded liabilities.

Using methods and embodiments described herein, a consumer may develop a strategy of moving assets from managed risks—in which the investor hopes for an adequate income stream amid uncertain market returns—to a blend of transferred risks, purchasing high quality guaranteed income, and letting the sellers of those products manage the risks instead, which they are in a better position to do by virtue of pooled risks guided by actuarial science. Risks associated with uncertain changes in tax rates can never be transferred. Opportunities exist for transferring most other risks, however, including the uncertain cost of longevity. When a consumer purchases a fixed annuity, the Curve S/Sᵢ shifts downward, corresponding to a lower remaining cost of financial adequacy now that a portion of liabilities have been covered. The growing market asset line shifts downward as well, reflecting the transfer of funds to the annuity contract, and then the remaining market assets continue their trajectory in response to the vagaries of market performance.

The Curve S/Sᵢ illustrated in FIG. 1 provides a snapshot of the “big picture” of inter-related concerns shaping retirement planning, including consumption levels, lifestyle, assets, income, social security, and retirement age, and is thus consistent with calls for more holistic approaches to retirement finance planning beyond the framework provided by the traditional capital model. Through a combination of risk transfer and risk management, consumption-based planning framework described herein offers individuals greater control over their retirement planning than is possible under conventional capital models, in which consumers and financial planning professionals only control the assumptions they make regarding rates of return, market volatility, and longevity. A consumption-based framework, in contrast, uses real and up-to-date data on current personal consumption levels combined with available price data for promise-based income.

Methods and embodiments described herein may affect consumer behavior. When a person relying on a traditional capital model sees how far they are from a retirement number, such as $2.86 million, they may be tempted to engage in high-risk investing, or may simply stop planning and hope for the best. But a person who can achieve financial adequacy sooner and understands exactly how much is required to fund it, has more discretion in their investment and consumption choices and can modify their behavior accordingly. Under traditional capital models, consumer discretion comes in the form of choosing an estimated rate of return and later making year-to-year adjustments in discretionary consumption.

The foregoing description of preferred embodiments of the present disclosure has been presented for purposes of illustration and description. The described preferred embodiments are not intended to be exhaustive or to limit the scope of the disclosure to the precise form(s) disclosed. Obvious modifications or variations are possible in light of the above teachings. The embodiments are chosen and described in an effort to provide the best illustrations of the principles of the disclosure and its practical application, and to thereby enable one of ordinary skill in the art to utilize the concepts revealed in the disclosure in various embodiments and with various modifications as are suited to the particular use contemplated. All such modifications and variations are within the scope of the disclosure as determined by the appended claims when interpreted in accordance with the breadth to which they are fairly, legally, and equitably entitled.

What is claimed is:

1. A method of electronically calculating a cost of funding an acceptable retirement of an individual, the method comprising:
receiving consumption data corresponding to a current or intended level of financial consumption of the individual;
calculating a required annual income of the individual based on received consumption data of the individual;
receiving portfolio data corresponding to a balance of a retirement portfolio of the individual;
retrieving cost data corresponding to costs of annuity products purchased at a plurality of ages of the individual;
plotting an estimated future balance of the retirement portfolio of the individual at an assumed rate of return against a plurality of ages of the individual;
plotting costs of the annuity products against the plurality of ages of the individual;
visually displaying the plotted estimated future balance of the retirement portfolio of the individual and the costs of annuity products.

2. The method of electronically calculating a cost of funding an acceptable retirement of claim 1, wherein cost data is retrieved from one or more third party data sources, the third party data sources including at least one provider of annuities.

3. The method of claim 1, wherein the visually displayed plot is iteratively updated based on annuity cost data from the one or more third party data sources.

4. The method of claim 1, wherein visually displaying the plotted estimated future balance of the individual and the cost of the annuity product further includes visually displaying a curve showing an intersection of the estimated future balance and the cost of annuity products.

5. The method of claim 1, further comprising receiving parameters of a prospective retiree on a user device.
